(19) United States
(12) Patent Application Publication
(10) Pub. No.: US 2025/0219315 A1
(43) Pub. Date: Jul. 3, 2025

(54) ELECTRICAL CONNECTOR WITH AN IMPROVED INTERLOCKING MECHANISM

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: GAO XIANG, Shenzhen (CN); DE-JIN CHEN, Shenzhen (CN); YU-SAN HSIAO, New Taipei (TW)

(21) Appl. No.: 18/989,804

(22) Filed: Dec. 20, 2024

(30) Foreign Application Priority Data
Dec. 29, 2023 (CN) 202311851728.0
Dec. 29, 2023 (CN) 202323637308.0

(51) Int. Cl. H01R 13/436; H01R 13/504; H01R 13/627; H01R 13/639

(52) U.S. Cl. CPC H01R 13/4362; H01R 13/504; H01R 13/6272; H01R 13/639

(57) ABSTRACT

An electrical connector includes: a housing comprising an elastic locking arm; a conductive assembly comprising an inner conductor and a cable connected with the inner conductor; and an interlocking member, movably set to the housing, wherein the locking arm is connected to the housing at a middle portion thereof and has a front arm portion and a rear arm portion, the interlocking member comprises a base portion, a pair of installation beams located at two sides of the base portion, a first locking portion extending forward from the base portion and a second locking portion connecting with the pair of installation beams, and the first locking portion presses downward against the front arm portion and the second locking portion is under and abuts upwardly against the rear arm portion when the interlocking member is moved to a locking position.

### BACKGROUND OF THE INVENTION

### Field of the Invention

The present invention relates to an electrical connector with an improved interlocking mechanism.

### Description of Related Arts

U.S. Pat. No. 10,230,197 discloses an electrical connector which comprises a latching device for locking with a mating connector and a connector position assurance. The latching device comprises two latching elements and a latching protrusion connecting the two latching elements. The connector position assurance is assembled to a rear end of the connector and comprises an interlocking element which covers the latching protrusion of the latching device for preventing the latching protrusion from being operated accidentally. However, rear ends of the latching elements are gapped with the connector position assurance such that the rear ends of the latching elements may be pressed to release the latching protrusion from a locking hole of the mating connector.

Therefore, it is necessary to provide an electrical connector with an improved interlocking mechanism.

### SUMMARY OF THE INVENTION

The object of the present invention is to provide an electrical connector with an improved interlocking mechanism.

To achieve the above object, an electrical connector comprises: a housing comprising an elastic locking arm; a conductive assembly comprising an inner conductor and a cable connected with the inner conductor; and an interlocking member, movably set to the housing, wherein the locking arm is connected to the housing at a middle portion thereof and has a front arm portion and a rear arm portion, the interlocking member comprises a base portion, a pair of installation beams located at two sides of the base portion, a first locking portion extending forward from the base portion and a second locking portion connecting with the pair of installation beams, and the first locking portion presses downward against the front arm portion and the second locking portion is under and abuts upwardly against the rear arm portion when the interlocking member is moved to a locking position.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of this present invention;

FIG. 2 is an exploded perspective view of the electrical connector in FIG. 1;

FIG. 3 is another exploded perspective view of the electrical connector in FIG. 2;

FIG. 4 is an exploded perspective view of the electrical connector in FIG. 1, wherein the interlocking member is separated with the electrical connector;

FIG. 5 is a cross-sectional view of the electrical connector along line A-A of FIG. 1;

FIG. 6 is a cross-sectional view of the electrical connector along line B-B of FIG. 1, wherein the interlocking member is in an initial position;

FIG. 7 is a cross-sectional view of the electrical connector along line B-B of FIG. 1, wherein the interlocking member is in a locking position;

FIG. 8 is an exploded perspective view of a conductive assembly;

FIG. 9 is a cross-sectional view of the exploded conductive assembly of FIG. 8;

FIG. 10 is a perspective view of the terminal position assurance;

FIG. 11 is a cross-sectional view of the electrical connector along line C-C of FIG. 1;

FIG. 12 is a cross-sectional view of the electrical connector along line D-D of FIG. 1, wherein the terminal position assurance is in a first position; and

FIG. 13 is a cross-sectional view of the electrical connector along line D-D of FIG. 1, wherein the terminal position assurance is in a second position.

### DETAILED DESCRIPTION OF THE PREFERRED EMBODIMENT

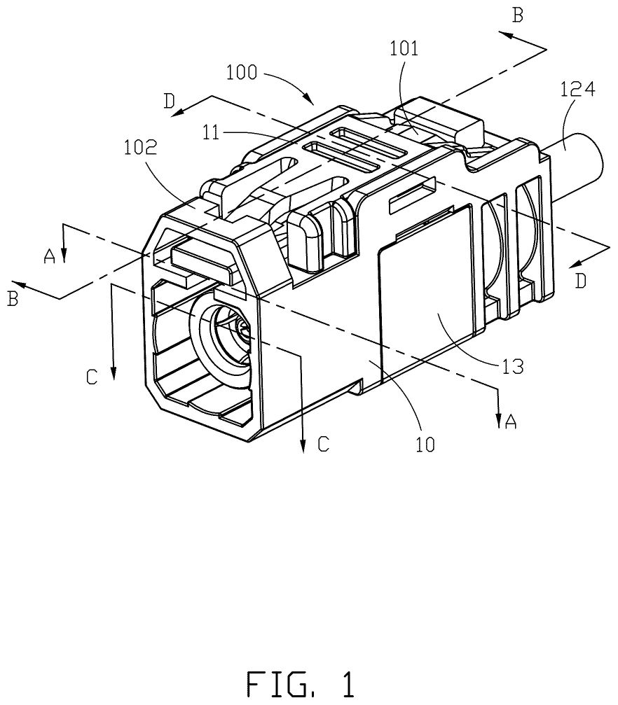

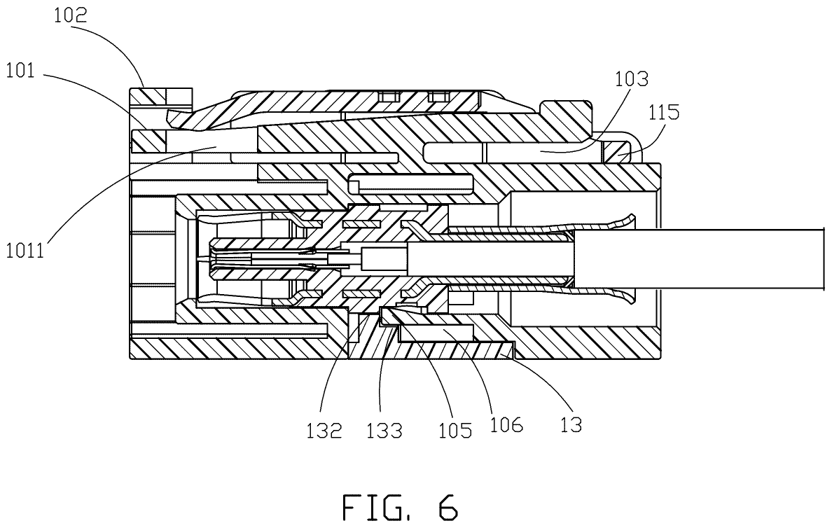

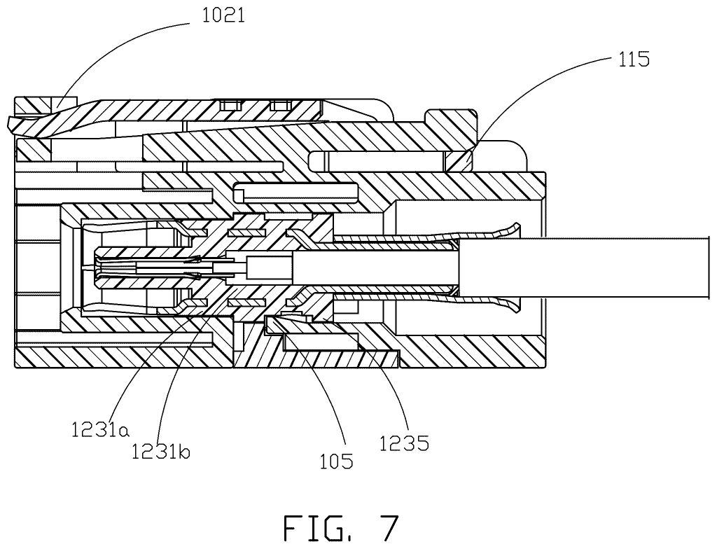

Referring to FIGS. 1-4, an electrical connector 100 comprises a housing 10, a conductive assembly 12 retained in the housing 10 and an interlocking member 11. The housing has an elastic locking arm 101 which is connected to the housing 10 at a middle portion thereof and has a front arm portion and a rear arm portion. The conductive assembly 12 comprises conductive terminals, an insulator 123 used for isolating different conductive terminals, and a cable connected to a rear end of the conductive terminals. The conductive terminals comprise an inner conductor 121 and an outer conductor 122, and the insulator 123 is set between the inner conductor 121 and the outer conductor 122. The interlocking member 11 comprises a base portion 111, a pair of installation beams 112 located at two sides of the base portion 111 correspondingly, a first locking portion 114 extending forwardly from the base portion 111, and a second locking portion 115 connecting with the two installation beams 112. The interlocking member 11 is assembled to the housing 10 and covers most of the locking arm 101. Combining with FIGS. 6-7, the rear portion of the interlocking member 11 and an upper face of the housing 10 are gapped with each other by a space 103. When the interlocking member 11 is moved to a locking position in place along the housing 10 forward, the first locking portion 114 covers the locking arm 101 and presses downward against a front arm portion, the second locking portion 115 goes into the space 103 abuts against a rear arm portion upwardly, so the locking arm 101 can't be pressed by the rear portion thereof accidently.

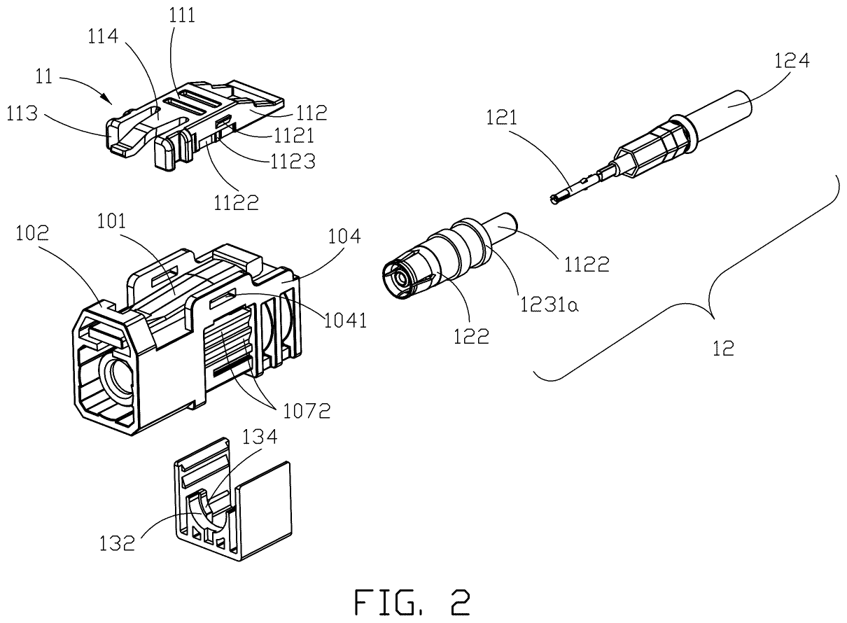

Referring to FIGS. 2-4, the base portion 111 is located between the two installation beams 112, the second locking portion 115 is connected to rear ends of the two installation beams 112, and an window is framed by the base portion 111, the second locking portion 115 and the two installation beams 112. As the interlocking member 11 moves forward, the rear arm portion goes through the window and is exposed outside the window with the second locking portion 115 goes into the space 103, and the base portion 111 and the first locking portion 114 cover the locking arm 101. Plural ribs 1111 or grooves which extend in a transverse direction perpendicular to a front-rear direction on the base portion 111 for a better operation of the interlocking member 11. In this embodiment, a pair of side walls 104 extend upwardly from two sides of the housing 10, an upper face of the base portion 111 are substantially flush with an upper face of the two side walls 104. The installation beam 112 has at least one stopping block 113 which protrudes outwardly along the transverse direction from a front portion thereof and can act as a lateral operating portion to move the interlocking member 11. Preferably, each of the two installation beams 112 has two stopping blocks 113. The front portion of the housing 10 has a front limiting portion 102, which is configured as an arc and spans the front arm portion. The stopping blocks 113 are located between the front limiting portion 102 and corresponding side wall 104, and thus, the interlocking member 11 is able to move between the initial position and the locking position by operating the stopping block 113.

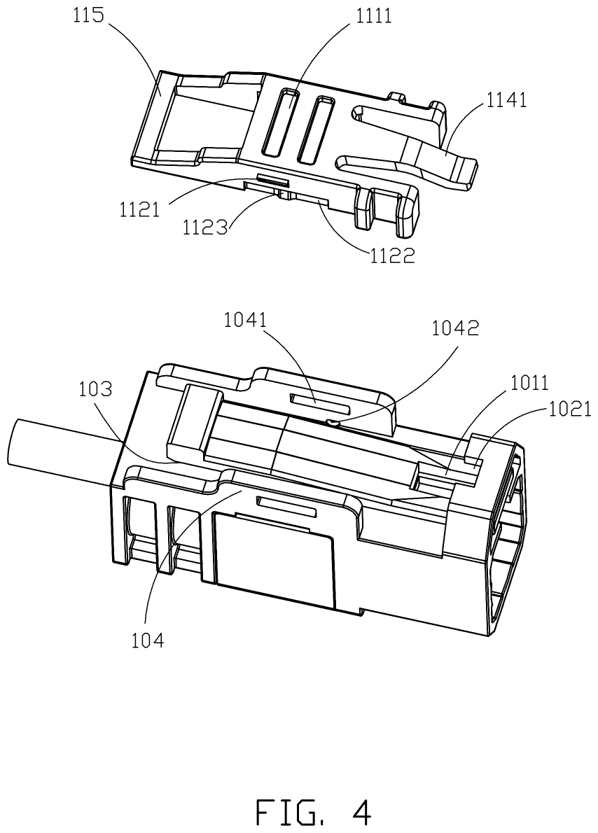

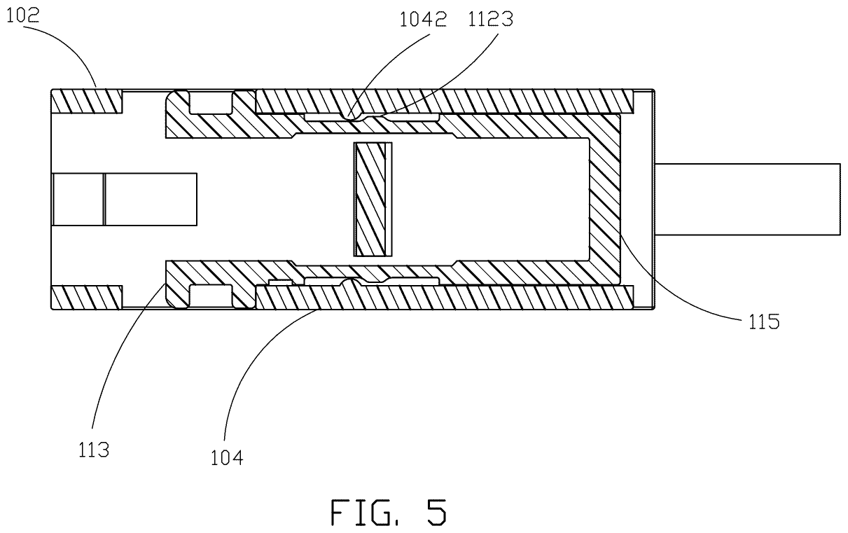

Referring to FIGS. 4-5, each installation beam 112 has an ear portion 1121 at an outside thereof. Each side wall has a guiding slot 1041 in which the ear portion 1121 located and the interlocking member 11 is able to move by the ear portion 1121 moving in the guiding slot 1041. Each side wall 104 is provided with a protrusion 1042 which extends inwardly from an inside thereof and is over the upper face of the housing 10. The outside of each installation beam 112 is provided with a groove 1122 in which a stopper 1123 is located and the groove 1122 is divided into two parts by the stopper 1123. When the interlocking member 11 moves along the housing 10 by operating the stopping block 113, the protrusion 1042 climb over the stopper 1123 to move from one part of the groove 1122 to another part to make the interlocking member 11 be alternated between the initial position and the locking position. The groove 1122 is under the ear portion 1121 and the protrusion 1042 extends from the inside of one side wall 104 towards another side wall 104.

Referring to FIGS. 6-7, the locking arm 101 extends forward until a front end thereof is under the front limiting portion 102. The first locking portion 114 is configured as an elastic locking tongue 1141, the front arm portion is provided with an opening 1011 in which a free end of the locking tongue is received when the interlocking member 11 is at the initial position. when the connector and a mating connector (not shown) are mated with each other, a free end of a mating locking member (not shown) of the mating connector pushes the locking tongue 1141 up and makes the free end of the locking tongue 1141 escapes from the opening 1011. Therefore, the interlocking member 11 is able to move to the locking position from the initial position for making the locking tongue 1141 inserted into a space between the front limiting portion 102 and the locking arm 101, and the second locking portion 115 inserted into the space 103. The front limiting portion 102 is provided with an avoiding notch 1021 to avoid the first locking portion 114 from touching the front limiting portion 102 accidently when the interlocking member 11 moves forward.

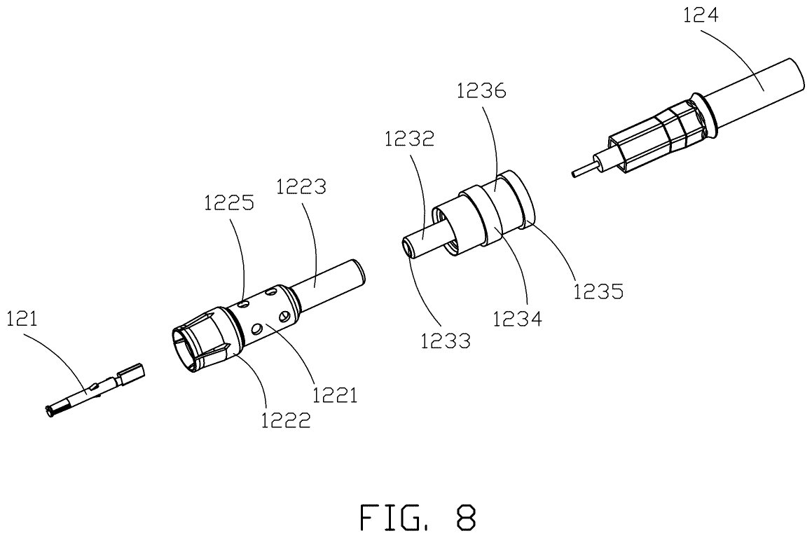

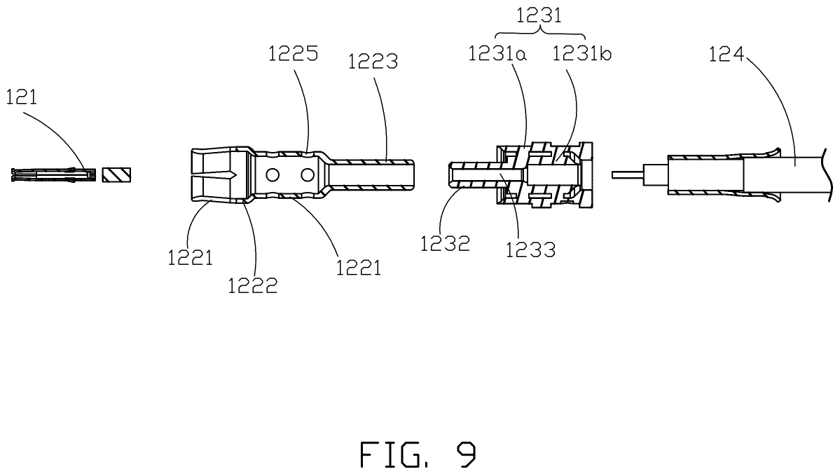

Referring to FIG. 2, FIG. 6-7 and FIGS. 8-9, the insulator 123 comprises a main portion 1231, a thinned portion 1232 extending forward from the main portion 1231 and a tunnel 1233 going through the thinned portion 1232 and the main portion 1231. The inner conductor 121 is received in the tunnel 1233. The outer conductor 122 comprises a cylindrical fixing portion 1221 which is embedded in the main portion 1231 and a cylindrical mating portion 1222 extending from the fixing portion 1221 forward. A diameter of the mating portion 1222 is larger than a diameter of the fixing portion 1221. To improve the elasticity of the mating portion 1222, a front end of the mating portion 1222 is divided into plural elastic pieces 1224 along a circumferential direction. The fixing portion 1221 has plural holes 1225 into which the main portion 1231 goes to keep the fixing portion 1221 firmly embedded in the main portion 1231. Preferably, the fixing portion 1221 has four rows of holes with each row has two holes. The insulator 123 is fixed with the outer conductor 122 by injection molding. The main portion 1231 comprises two parts, one part is an inner portion 1231b between the inner conductor 121 and the outer conductor 122, the other part is an outer portion 1231a surrounding the outer conductor 122. The outer conductor 122 further comprises a rear contacting portion 1223 which is cylindrical for connecting the cable 124, and a diameter of the contacting portion 1223 is less than the diameter of the fixing portion 1221. The outer portion 1231a extends forwardly to the mating portion 1222 and extends backwardly to the contacting portion 1223, and thus, the outer portion 1231a is pressed between the conductive assembly 12 and the housing 10.

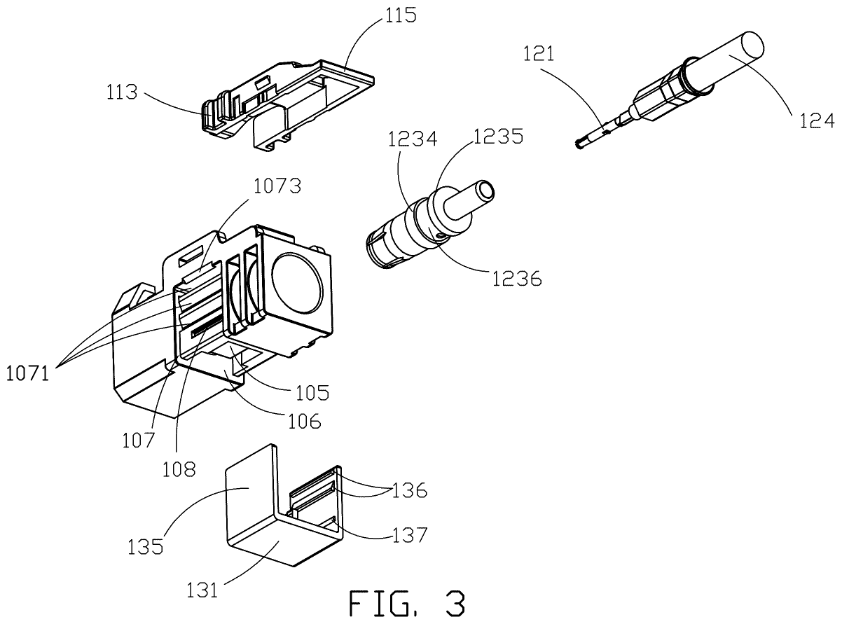

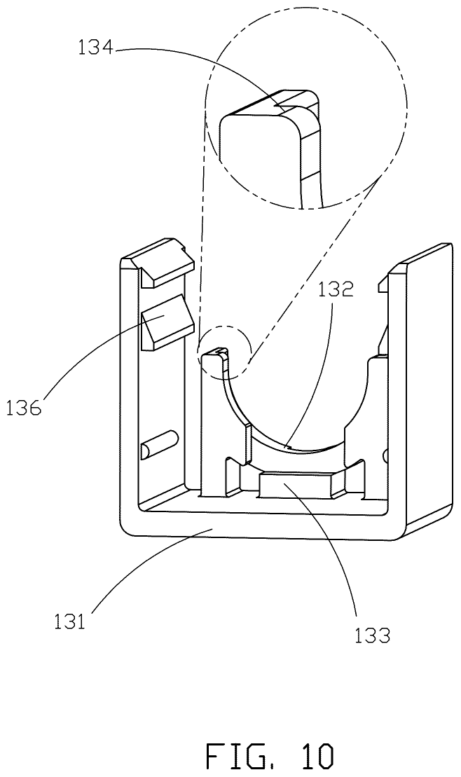

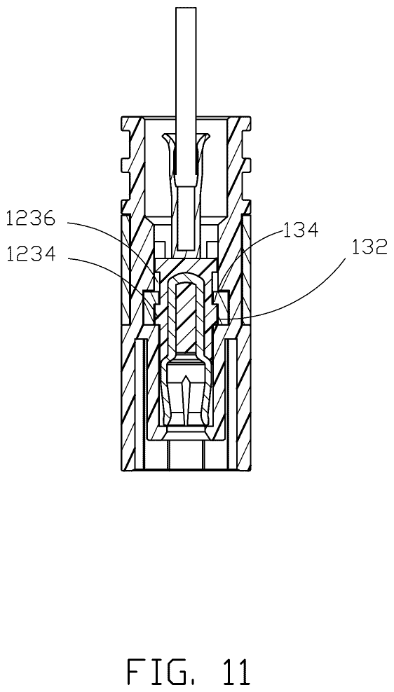

Referring to FIG. 3 and FIGS. 6-7, the housing 10 has an elastic abutting arm 105 extends forward, and the outer portion 1231a has a front convex ring 1234, a rear convex ring 1235, and a ring groove 1236 formed between the front convex ring 1234 and the rear convex ring 1235. The abutting arm 105 is clamped in the ring groove 1236 with a free end thereof abuts against a rear face of the front convex ring 1234. The housing has a front abutting portion 125 which protrudes inward, a front face of the front convex ring 1234 abuts against the front abutting portion 125 forwardly to prevent the conductive assembly 12 from moving forward. Combining with FIGS. 10-11, for a more stable fixation of the conductive assembly 12, a terminal position assurance (TPA) member is provided which comprises a base plate 131 and a pressing portion protrudes inwardly from the base plate 131, the pressing portion comprises a first pressing portion 132 and a second pressing portion 133 which is lower than the first pressing portion 132 along a radial direction, the first pressing portion 132 is arc-shaped and press inwardly against the front convex ring 1234 along the radial direction, the second pressing portion 133 presses inwardly against an outer side of the free end of the abutting arm 105 radially. The free end of the abutting arm 105 not only abuts against the rear face of the front convex ring 1234 but also abuts against a rear face of the first pressing portion 132 along an axis direction of the conductive assembly 12, that is, the free end of the abutting arm 105 abuts against both the front convex ring 1234 and the first pressing portion 132 along the axis direction of the conductive assembly 12. The pressing portion further comprises a third pressing portion 134 which is behind the first pressing portion 132, and the third pressing portion 134 abuts against the rear face of the front convex ring 1234 to prevent the conductive assembly 12 from moving backward.

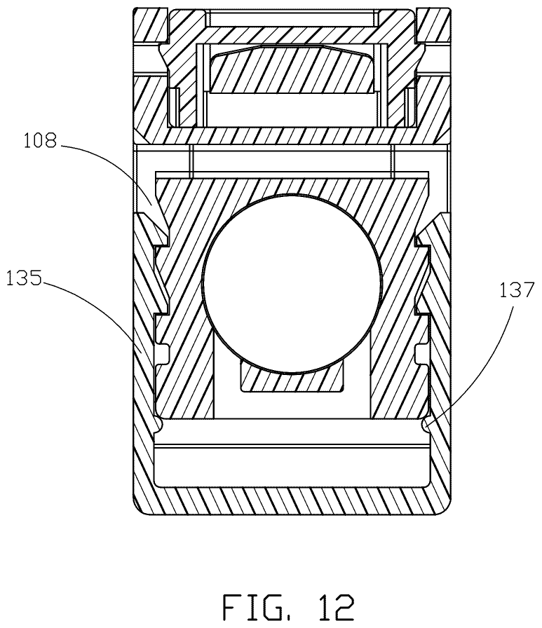

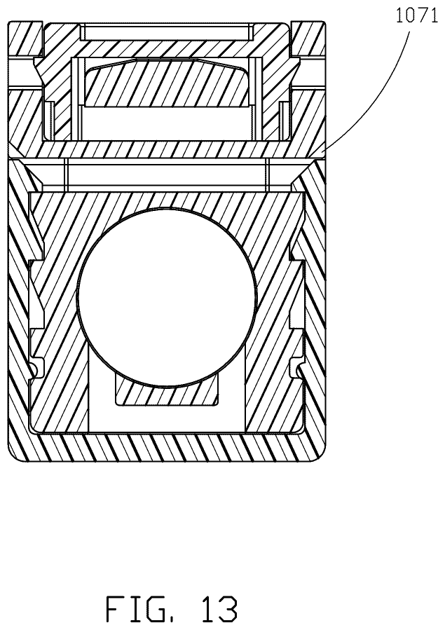

Referring to FIG. 3, the terminal position assurance member 13 further comprises a pair of latching plates 135 that extend from two sides of the base plate 131 correspondingly, and the terminal position assurance member 13 is configured as U shaped. Two locking ribs 136 are provided at an inside of each latching plate 135 and the locking ribs 136 are rowed in an upper-lower direction. The housing 10 has a receiving groove 107 recessed from two side walls and a lower wall thereof. The terminal position assurance member 13 is received in the in the receiving groove 107 and an outer face thereof is aligned with an outer face of the housing 10. Three locking slots 1071 which are parallel to each other are formed at each side wall. The three locking slots 1071 comprise an upper slot, a middle slot and a lower slot. The terminal position assurance member 13 can move between an initial position/first position and a latching position/second position. The two locking ribs 136 are correspondingly received in the lower slot and the middle slot when the terminal position assurance member 13 is in the initial position as shown clearly in the FIG. 12, and the two locking ribs 136 are correspondingly received in the upper slot and the middle slot when the terminal position assurance member 13 is in the latching position as shown clearly in FIG. 13. When the terminal position assurance member 13 is in the latching position, the terminal position assurance member 13 can prevent the conductive assembly 12 from moving with the pressing portion thereof abuts against the conductive assembly 12. To facilitate the terminal position assurance member 13 to move from the first position to the second position upward, a guiding face 1072 which inclines upward and outward is provided between every two locking slots 1071. The housing 10 is provided with an avoidance slot 1073 over the locking slot 1071 in which fingers can be put for removing the terminal position assurance member 13.

Referring to FIG. 3, in order to judge whether the terminal position assurance member 13 has been moved to the second position in place, an indicator rib 137 with an arc-shaped surface is provided at the inside of each latching plate 135, and an indicator slot 108 is provided at each side wall of the housing 10 for receiving the indicator rib 137. Referring to FIG. 12, the indicator rib 137 is under and abuts against the lower wall of the housing 10 when the terminal position assurance member 13 is in the first position, and the indicator rib 137 comes into the indicator slot 108 when the terminal position assurance member 13 moves to the latching position accompanied with a “click” sound. Then people can know whether the terminal position assurance member 13 has moved to the second position rightly.

Referring to FIG. 3 and FIG. 13, an assembling method of the electrical connector is described. Firstly, injection mold the insulator 123 with the outer conductor 122 by plural injection molding holes 1225, and then assemble the inner conductor 121 connected with a cable into the tunnel 1233 of the insulator 123 to form the conductive assembly 12; secondly, insert the conductive assembly 12 into the housing 10 from a rear end of the housing 10 until the elastic arms 105 snap into the ring groove 1236; thirdly, assemble the terminal position assurance member 13 into the receiving groove 107 to further retain the conductive assembly 12 into the housing 10.

The above-mentioned embodiments are only preferred embodiments of the present invention, and should not limit the scope of the present invention, any simple equivalent changes and modifications made according to the claims of the present invention and the contents of the description should still belong to the present invention.

1. An electrical connector comprising:
a housing comprising an elastic locking arm;
a conductive assembly comprising an inner conductor and a cable connected with the inner conductor; and
an interlocking member, movably set to the housing;
wherein the locking arm is connected to the housing at a middle portion thereof and has a front arm portion and a rear arm portion, the interlocking member comprises a base portion, a pair of installation beams located at two sides of the base portion, a first locking portion extending forward from the base portion and a second locking portion connecting with the pair of installation beams, and the first locking portion presses downward against the front arm portion and the second locking portion is under and abuts upwardly against the rear arm portion when the interlocking member is moved to a locking position.

2. The electrical connector as claimed in claim 1, wherein the housing has an arc front limiting portion at a front end thereof, and the front limiting portion spans the front arm portion.

3. The electrical connector as claimed in claim 1, wherein the second locking portion is lower than the base portion and configured as a horizontal bridge connecting the two installation beams, and the second locking portion, the base portion and the two installation beams commonly form a window through which the rear arm portion goes.

4. The electrical connector as claimed in claim 1, wherein the front arm portion is provided with an opening, the first locking portion is configured as a locking tongue, and a free end of the locking tongue is received in the opening to stop the interlocking member from moving when the interlocking member is at an initial position.

5. The electrical connector as claimed in claim 4, wherein the rear arm portion is gapped with an upper face of the housing by a space, and the second locking portion of the interlocking member goes into the space when the interlocking member is moved from an initial position to the locking position.

6. The electrical connector as claimed in claim 3, wherein each installation beam has an ear portion at an outside thereof, the housing has a pair of side walls extending upwardly from two side edges thereof, and each side wall is provided with a guiding slot receiving the ear portion for a guided movement of the interlocking member.

7. The electrical connector as claimed in claim 6, wherein each side wall is provided with a protrusion at an inside thereof, the installation beam is provided with a groove at an outside thereof, a stopper is set in the groove and divides the groove into two parts, and the interlocking member is able to move from an initial position to the locking position when the protrusion moves in the groove and climbs over the stopper.

8. The electrical connector as claimed in claim 1, wherein the base portion has plural ribs at an upper face thereof extending along a transverse direction.

9. The electrical connector as claimed in claim 1, wherein each installation beam has two stopping blocks protruding laterally from a front portion thereof and movably located between the front limiting portion and a corresponding side wall.

10. An electrical connector, comprising:
a housing; and
a conductive assembly retained in the housing, the conductive assembly comprising an inner conductor, an outer conductor, a cable connected with the inner conductor and the outer conductor, and an insulator fixed between the inner conductor and the outer conductor; wherein
the insulator comprises a main portion, a thinned portion extending forward from the main portion, and a tunnel through the main portion and the thinned portion, the inner conductor is received in the tunnel, the outer conductor comprises a fixing portion embedded in the main portion, a mating portion extending from the fixing portion and surrounding the thinned portion, and plural holes provided on the fixing portion, the main portion goes through the holes, and the fixing portion is embedded in the main portion.

11. The electrical connector as claimed in claim 10, wherein the insulator is injection molded with the outer conductor through the injection holes first, and then the inner conductor is inserted into the tunnel.

12. The electrical connector as claimed in claim 11, wherein the holes comprise four rows with each row having two holes.

13. The electrical connector as claimed in claim 10, wherein the outer conductor comprises a contacting portion extending rearward from the fixing portion for connecting with the cable, and a diameter of the mating portion is greater than a diameter of the fixing portion and a diameter of the contacting portion is less than the diameter of the fixing portion.

14. The electrical connector as claimed in claim 13, wherein the insulator comprises an inner portion inside the outer conductor and an outer portion outside the outer conductor, and the outer portion extends forward to the mating portion and the inner portion extends backward to the contacting portion.

15. The electrical connector as claimed in claim 13, wherein a front end of the mating portion is divided into plural elastic pieces circumferentially.

16. The electrical connector as claimed in claim 10, wherein the main portion comprises a front convex ring and a rear convex ring provided at an outside thereof and a ring groove between the front convex ring and the rear convex ring, and the housing has plural elastic arms extending into the ring groove from an inside thereof with free ends of the elastic arms abutting forwardly against the front convex ring.

17. The electrical connector as claimed in claim 16, further comprising a terminal position assurance member having a base plate and a pressing portion protruding inwardly from the base plate, and wherein the pressing portion comprises a first pressing portion and a second pressing portion, the first pressing portion presses radially against the front convex ring, and the second pressing portion abuts radially against the free ends of the elastic arms.

18. The electrical connector as claimed in claim 17, wherein the pressing portion comprises a third pressing portion abutting against a rear face of the front convex ring to prevent the conductive assembly from moving backward.
